(19) United States
(12) Patent Application Publication
(10) Pub. No.: US 2025/0177790 A1
(43) Pub. Date: Jun. 5, 2025

(54) Hose Assembly

(71) Applicant: 1005, LLC, Birmingham, MI (US)

(72) Inventor: Pat J Reedy, Grand Ledge, MI (US)

(73) Assignee: 1005, LLC, Birmingham, MI (US)

(21) Appl. No.: 19/044,964

(22) Filed: Feb. 4, 2025

Related U.S. Application Data
(63) Continuation-in-part of application No. 16/965,141, filed on Jul. 27, 2020.
(60) Provisional application No. 62/626,760, filed on Feb. 6, 2018.

(51) Int. Cl. A62C 33/04; A62B 7/02; A62B 7/12

(52) U.S. Cl. CPC A62C 33/04; A62B 7/02; A62B 7/12

(57) ABSTRACT

A hose apparatus connects an air supply and a water supply to a user. The hose apparatus includes a flexible water hose and a gas hose. An inlet hose end connector is attached to water and gas inlet ends. An outlet hose end connector attached to water and gas outlet ends. The second hose end connector has a third passageway to allow the water to pass out of the hose apparatus independently of the gas and a fourth passageway to allow the gas to pass out of the hose apparatus independently of the water. The third passageway is separated from the fourth passageway. An outer jacket made of weather-resistant material, surrounds the flexible water hose and the gas hose. The inlet hose end connector includes a first sealing surface facing away from the flexible gas hose to receive and seal the gas inlet end thereagainst.

This application is a continuation-in-part of United States patent application having Ser. No. 16/965,141, filed Jul. 27, 2020, which is a national stage entry of PCT/US2019/016501, filed Feb. 4, 2019, which claims priority to a United States provisional patent application having Ser. No. 62/626,760, filed Feb. 6, 2018, the disclosures of which are hereby incorporated entirely herein by reference.

### BACKGROUND OF THE INVENTION

### 1. Field of the Invention

This invention relates generally to a hose apparatus. More particularly, the invention relates to a hose apparatus providing independent channels of transport for water and breathable air.

### 2. Description of the Related Art

One of the main reasons that firefighters face such danger in fighting fires is that they run out of air. Typically, air is supplied to a firefighter by tanks carried on the firefighter's back. These tanks have a limited air supply, which in turn limits a firefighter's ability to fight fires for an extended period without running out of air. An already dangerous situation is compounded when a firefighter is trapped or lost in a flaming structure with little air remaining in their tank.

U.S. Pat. No. 6,520,178 sought to solve this problem by combining a water hose and air hose, disclosing two air hoses located within a water hose. This patent further disclosed a system allowing for connection and disconnection of the air supply to the firefighter's mask that could be used with standard self-contained breathing apparatus (SCBA) used by firefighters and including a mask and a regulator. However, the system disclosed does not include a connection system that is quick and easily sealable by an operator wearing protective gear.

### SUMMARY OF THE INVENTION

A hose apparatus is connectable to an air supply supplying a gas and a water supply supplying water. The hose apparatus includes a flexible water hose extending between a water inlet end and a water outlet end. A gas hose extends between a gas inlet end and a gas outlet end, wherein the water and gas inlet ends are disposed adjacent to each other and the water and gas outlet ends are disposed adjacent to each other. An inlet hose end connector is attached to the water and gas inlet ends. The inlet hose end connector has a first passageway to receive the water into the hose apparatus independently of the gas, and a second passageway to receive the gas into the hose apparatus independently of the water. The first passageway is separated from the second passageway. The hose apparatus also includes an outlet hose end connector attached to said water and gas outlet ends. The second hose end connector has a third passageway to allow the water to pass out of the hose apparatus independently of the gas and a fourth passageway to allow the gas to pass out of the hose apparatus independently of the water. The third passageway is separated from the fourth passageway. An outer jacket made of weather-resistant material, surrounds both the flexible water hose and the flexible gas hose, collectively. The inlet hose end connector includes a first sealing surface facing away from the gas hose to receive and seal the gas inlet end thereagainst.

### BRIEF DESCRIPTION OF THE DRAWINGS

A more complete understanding of the invention may be derived by referring to the detailed description and claims when considered in connection with the Figures, wherein like reference numbers refer to similar items throughout the Figures, and:

FIG. 1 is a perspective view of one embodiment of the hose apparatus being held at one end by a user and being connected to air and water supply lines at a second end with the water coming eventually from a fire truck;

FIG. 2 is a side view of the hose apparatus, with interior elements thereof shown in phantom;

FIG. 3A is an end view of a nozzle adaptor;

FIG. 3B is a perspective view of the nozzle adaptor of FIG. 3A;

FIG. 3C is a side view of the nozzle adapter of FIG. 3A;

FIG. 4A is an end view of an inlet hose end connector;

FIG. 4B is a perspective view of the inlet hose end connector of FIG. 4A;

FIG. 4C is a side view of the inlet hose end connector of FIG. 4A.

FIG. 5A is an end view of an outlet hose end connector;

FIG. 5B is a perspective view the outlet hose end connector of FIG. 5A;

FIG. 5C is a side view of the outlet hose end connector of FIG. 5A;

FIG. 5D is a second side view, partially cut away, of the outlet hose end connector of FIG. 5A;

FIG. 6 is an exploded perspective view of the hose apparatus;

FIG. 7 is a perspective view of a user operating the hose apparatus, shown partially cut away;

FIG. 8 is a perspective view of a user operating the hose apparatus; and

FIG. 9 is a side view of an air tank which could be used in conjunction with the hose apparatus.

### DETAILED DESCRIPTION OF EMBODIMENTS

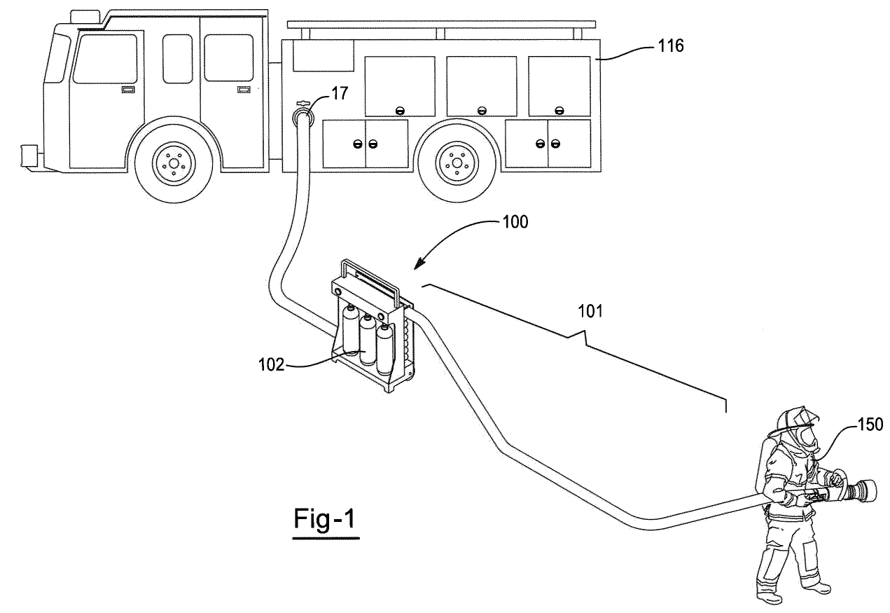

FIG. 1 shows a hose apparatus 101 connected to a water supply 17 and an air supply system 100 to provide water and air or other breathable gas to a user 150. The air supply system 100 provides a breathable gas stored in primary air supply tanks 102 and connects with the hose apparatus 101, which is connected at the other end to a self-contained breathing apparatus (SCBA) 152.

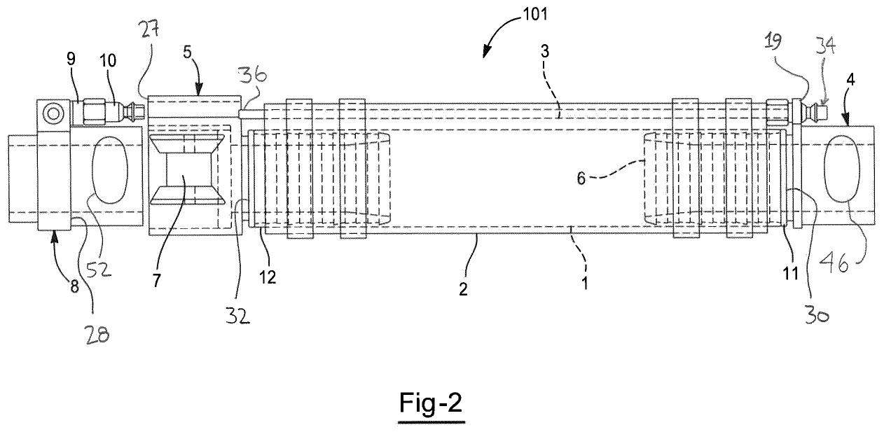

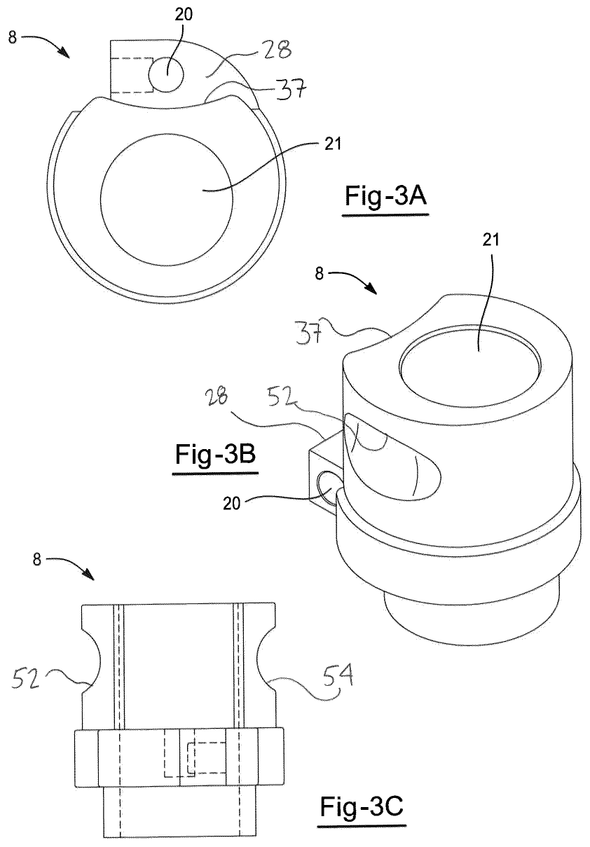

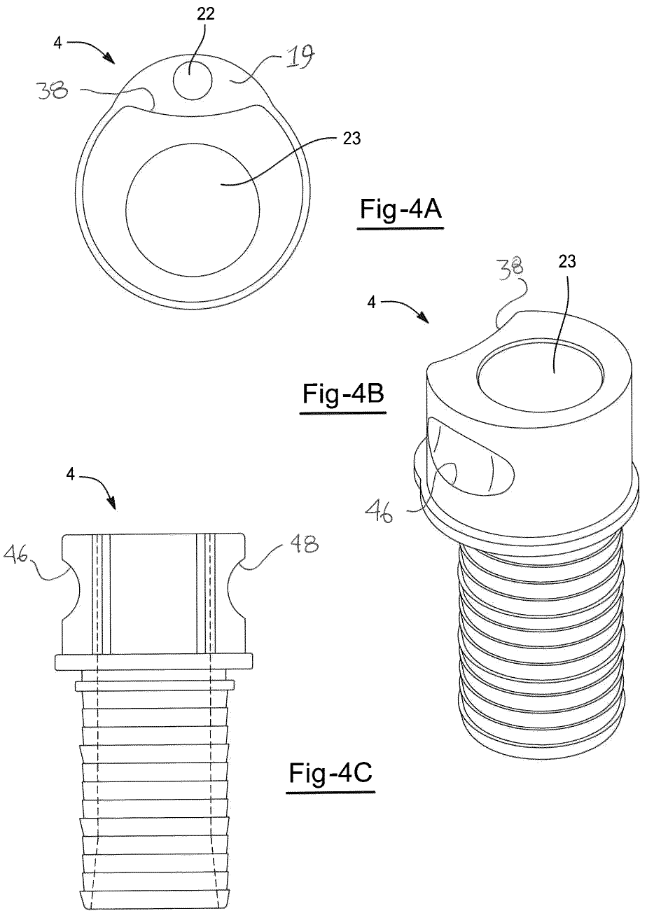

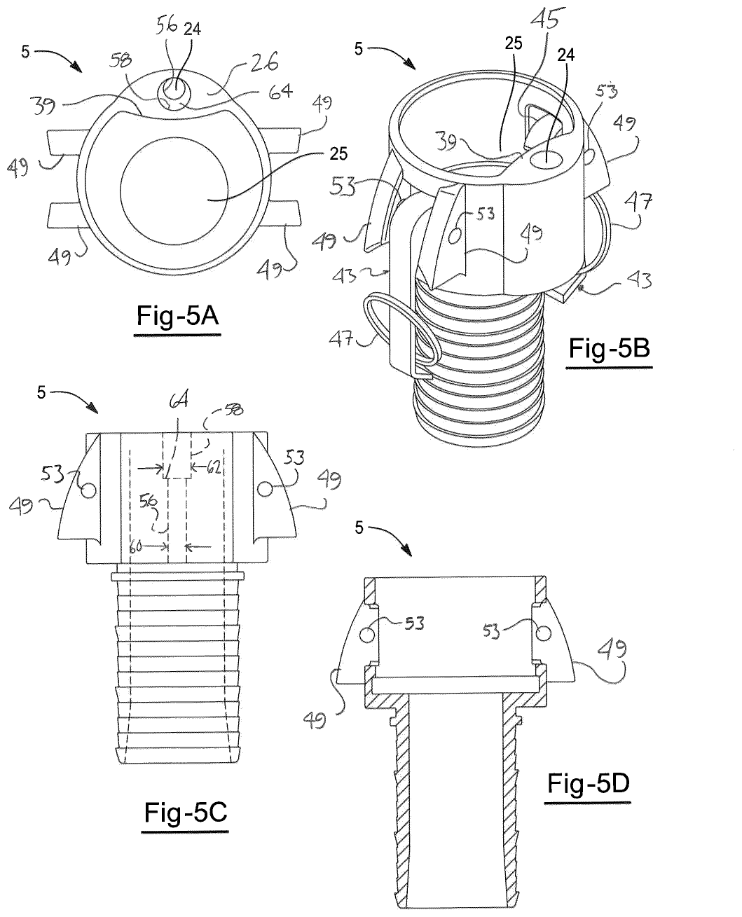

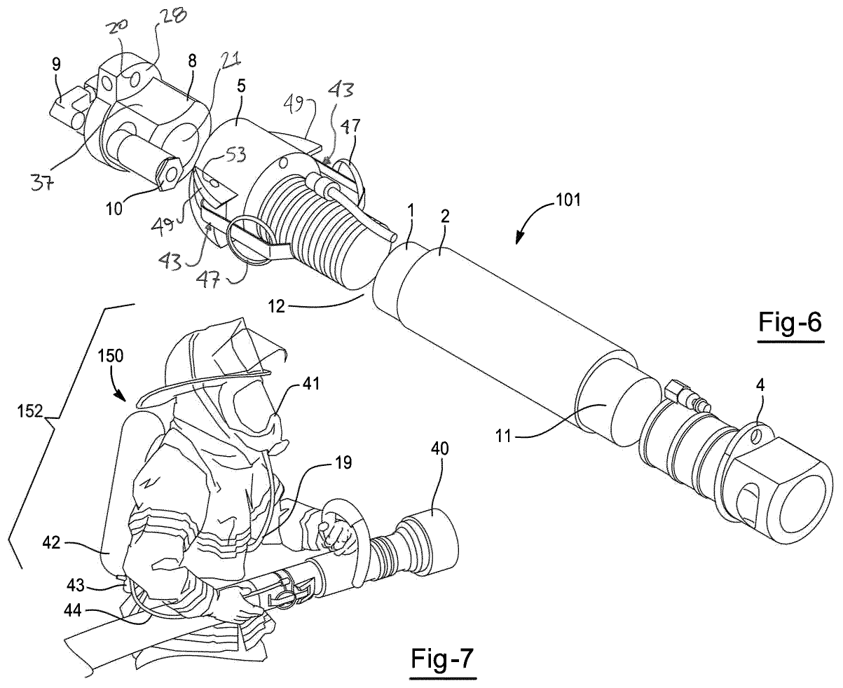

FIG. 2 shows the hose apparatus 101 having an inlet end 11 and an outlet end 12. An inlet hose end connector 4 and an outlet hose end connector 5 are secured to the inlet end 11 and the outlet end 12, respectively. The outlet hose end connector 5 includes a pair of lock access windows 7 (one shown in FIG. 2) to provide access to locking cam surfaces 52, 54 (discussed subsequently). As shown in FIGS. 4A-C, the inlet hose end connector 4 has a first passageway 23 and second passageway 22. Likewise, FIGS. 5A-D show the outlet hose end connector 5 having a third passageway 25 and a fourth passageway 24. The inlet hose end connector 4 includes an inlet sealing surface 19 facing outwardly away from a flexible water hose 1. The inlet sealing surface 19 seals the gas inlet end 34 thereagainst. The flexible water hose 1 is connected to the first passageway 23 and the third passageway 25 in a water-tight connection. The outlet hose end connector 5 includes an outlet sealing surface 27 facing away from the flexible gas hose 3 to receive and seal the outlet sealing surface 27 and a nozzle sealing surface 28 (of a nozzle adaptor 8 described below) together.

The outlet hose end connector 5 also includes at least two cam locking devices, generally shown at 43 (these cam locking devices are not shown in FIG. 2 for purposes of simplicity). The cam locking devices 43 include cam locking surfaces 45 (one shown in FIG. 5B) that engage the lock access windows 7 to lock the nozzle adapter 8 to the outlet hose end connector 5. These cam locking devices 43 operate in a single direction—they are one-way locking devices. The at least two cam locking devices 43 include grab rings 47 to aid in the locking of the nozzle adapter 8 to the outlet hose end connector 5. Two pivot wings 49 extend out of the outlet hose end connector 5 on either side of each of the at least two cam locking devices 43 to pivotally secure a pivot pin 53 in place about which the at least two cam locking devices 43 pivot.

Separately, the outlet hose end connector 5 is a coupler 5 that can be used independently from the hose apparatus 101. The coupler 5 is used to connect the hose apparatus 101 to the air supply system 100 and to the water source 17. In other words, the outlet hose end connector 5 is also the coupler 5 that connects the air supply system 100 and the water source 17 to the inlet hose end connector 4 of the hose apparatus 101. If a particular situation requires multiple hose apparatuses 101 to be connected in series (not shown in the drawings), the outlet hose end connector 5 acts as a coupler by connecting a first hose apparatus 101 to a second inlet hose end connector 4, thus acting as a coupler 5 for the two hose apparatuses 101.

The nozzle sealing surface 28 of the nozzle adapter 8 faces inwardly toward the flexible gas hose 3 to receive and seal the gas outlet end 36 thereagainst. The water hose 1 is preferably similar to standard firefighting water hoses and is preferably constructed of several layers of materials which are durable and flexible. The water hose 1 extends between a water inlet end 30 and a water outlet end 32. A flexible gas hose 3 is connected to the second passageway 22 and the fourth passageway 24 in a gas tight connection. The flexible gas hose 3 extends between a gas inlet end 34 and a gas outlet end 36. The flexible gas hose 3 is adjacent to but external to the flexible water hose 1. Each of the inlet hose end connector 4 and the outlet hose end connector 5 define a convex surface 38, 39 to enlarge the inlet 26 and outlet 27 sealing surfaces to enhance the ability to seal the gas inlet end 34 and the gas outlet end 36. An outer jacket 2 surrounds both the flexible water hose 1 and flexible gas hose 3. The flexible gas hose 3 may be constructed of any well-known material which can withstand high fluid pressure on the outside caused by the flow of water through the water hose 1 and high fluid pressure on the inside caused by the air moving through the gas hose 3. In one embodiment, the gas hose 3 is constructed of reinforced rubber tubing which is approved for human use. The ability of the gas hose 3 to carry breathable gas up to 5000 psig enables the gas hose 3 to be used to fill the air tanks of the users. Also, preferably, the gas hose 3 is constructed of a material which does not have memory. The gas hose 3 must be supple enough to bend 180° and still spring back to its original shape to prevent damage to the gas hose 3 due to repeated bending and folding for storage. The gas hose 3 must also be constructed of a material which will not contaminate the air such as air hoses used and approved for scuba diving.

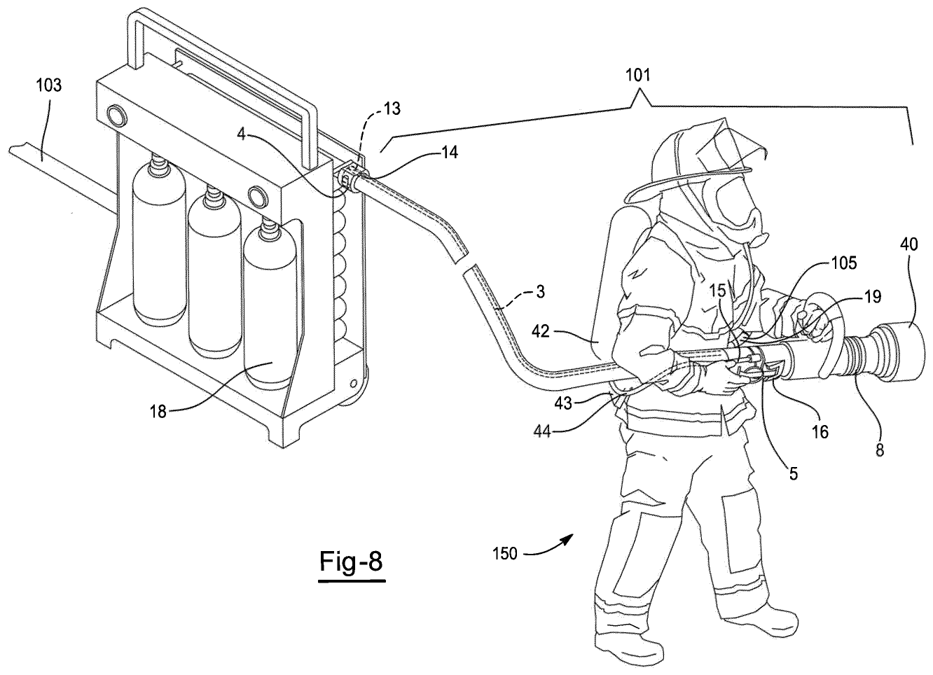

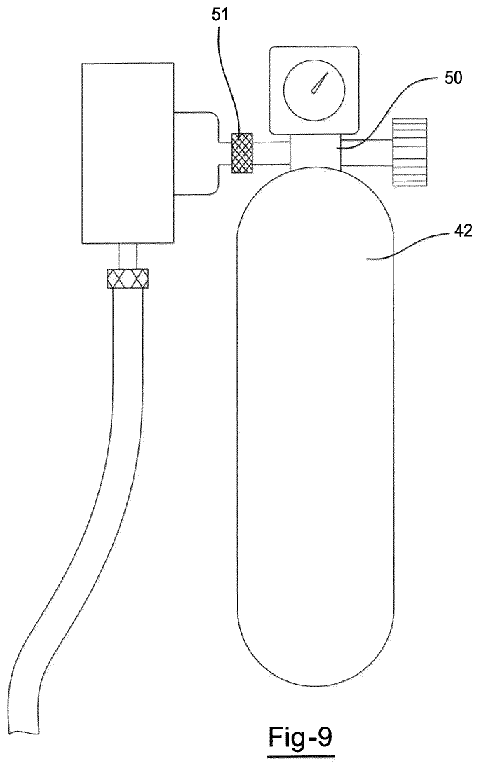

FIG. 8 shows a first connection 13 on the inlet hose end connector 4 for connecting a source of water 17 through the first passageway 23, the flexible water hose 1, and the third passageway 25. A second connection 14 on the first hose end connector 4 connects a source of breathable gas 18 through the second passageway 22, the flexible gas hose 3, and the fourth passageway 24. A third connection 15 on the second hose end connector 5 connects the breathable gas hose 3 to a pressure regulator 105 as part of a user's breathing apparatus 152, and a fourth connection 16 on the second hose end connector connects a nozzle adaptor 8 for dispensing water connected to the third passageway. The nozzle adapter 8 is removably securable to the outlet hose end connector 5. The nozzle sealing surface 28 faces toward the flexible gas hose 3 for receiving and sealing the gas outlet end 36 thereagainst. The outlet hose end connector 5 includes an outlet sealing surface 27 facing away from the flexible gas hose 3 to receive and seal the outlet sealing surface 27 and the nozzle sealing surface 28 together. The inlet hose end connector 4 and the nozzle adapter 8 each define a convex surface 38, 37, respectively to enlarge inlet and outlet sealing surfaces. The outlet hose end connector 5 defines a first air hose tube 56 that is in fluid communication with the flexible gas hose 3 and a second air hose tube 58 fixedly secured to the first air hose tube 56 providing the gas downstream. The first 56 and second 58 air hose tubes define first 60 and second 62 air hose diameters such that the second air hose diameter 62 is larger than the first air hose diameter 60 to reduce turbulence in the gas as it moves out of the gas hose 3. A relief 64 is created between the first 56 and second 58 air hose tubes. The first 56 and second 58 air hose tubes are axially offset.

As shown in FIGS. 4A through 5D, the inlet hose end connector's first passageway 23 is larger than the second passageway 22. The first passageway 23 connects a source of water to the flexible water hose 1. The second passageway 22, located above and separate from the first passageway 23, connects a source of breathable gas to the flexible gas hose 3. The inlet hose end connector 4 and the nozzle adaptor 8 each include at least two locking cam surfaces 46, 48, 52, 54 disposed equidistantly thereabout, respectively, to lock the hose apparatus to the water source 17 and a fire hose nozzle, respectively.

The third passageway 25 is larger than the fourth passageway 24. The third passageway 25 connects the flexible water hose 1 to a nozzle adaptor 8 in a sealingly secured manner. The fourth passageway 24, located above and separate from the third passageway 25, connects the flexible gas hose 3 to a pressure regulator 105 as part of a breathing apparatus, also in a sealingly secured manner.

The nozzle adaptor 8 is mounted on the outlet hose end connector 5. The inlet hose end connector 4 can be connected to a water source 17 or can be connected to a standard firefighting or other purpose water hose.

FIG. 7 shows the breathing apparatus for the user 150 preferably includes a first breathing hose 44, a regulator (not shown) and a breathing apparatus 41 and at least one air tank 42 carried on the back of the user 150. In the preferred embodiment, the first breathing hose 44 extends between the air tank 42 and the regulator and provides air from the tank 42 to the user 150. In one embodiment, the regulator is directly mounted on the breathing apparatus 41. The regulator allows high pressure, compressed gas to be used as the air supply.

The breathable gas and water hose apparatus 101 may be used in the primary breathing system or source of breathable gas for users 150 fighting a fire or otherwise delivering a source of water to a point. The breathable gas and water apparatus 101 is used as the last section of the water hose 1 used by the users 150. Limiting use of the breathable gas and water hose apparatus 101 to a single section of the water hose 1 eliminates the need to connect the breathable gas hose 44 from several air and water hose apparatuses 101 together. This reduces the risk of gas leakage and reduces the possibility of damage to the gas hose 3 which could result in gas leakage. Gas leakage in high pressure compressed gas systems could potentially be dangerous since the leaked gas could feed a fire. Any number of standard water hoses can be used to allow the needed length provided the last hose is the breathable gas and water hose apparatus 101. In the preferred embodiment, the breathable gas and water hose apparatus 101 has a length of between 50 and 150 feet (127 and 254 cm). However, it is understood that the breathable gas and water hose apparatus 101 can be of any length.

To use the hose apparatus 101 in the air supply system 100, the first passageway 23 of the gas and water apparatus 101 is attached to the outlet adaptor of the last section of a standard water hose 103. The inlet end of the standard water hose 103 is connected to a source of water. Alternatively, if only the breathable gas and water hose apparatus is used, the first passageway 23 of the inlet hose end connector 4 of the breathable gas and water hose apparatus 101 is connected directly to a source of water.

The air supply 100 is preferably positioned adjacent the inlet hose end connector 4 of the breathable gas and water hose apparatus 101. The air supply tube for the air supply is then connected to the plug on the inlet hose end connector 4. In the preferred embodiment, the air supply 102 provides breathable gas at a pressure of at least 200 psig with or without the use of a regulator 105. However, it is understood that the pressure of the breathable gas entering the second passageway 22 in the inlet hose end connector 4 must be great enough to provide sufficient breathable gas to the user 150 at the other end of the breathable gas and water hose apparatus 101. How much pressure is needed would depend on the length of the breathable gas and water hose apparatus 101, and the inner diameter of the breathable gas hose 3 and the number of persons using the breathable gas and water hose apparatus 101.

Air tanks 42 carried on the back of a user 150 may be used in conjunction with the hose apparatus 101, such that the apparatus 101 provides gas at a pressure of at least 110 psi and wherein the air tanks 42 include a pressure regulator 50 and a valve 51 which opens when air pressure from the apparatus 101 is below 110 psi.

It is understood that other breathable gases could also be provided through the breathable gas hose 3 of the breathable gas and water hose apparatus 101. It is also understood that other fluids could also be provided through the water hose 1 of the breathable gas and water hose apparatus 101, including but not limited to other firefighting fluids or flame-retardant materials, or other fluids used for applications unrelated to firefighting.

A secondary hose and breathing apparatus (not shown) could also be connected to any remaining plug. The secondary hose and breathing apparatus could then be used to provide breathable gas to a civilian trapped in a fire.

With reference to FIG. 7, once the users 150 are connected to the breathable gas and water hose apparatus 101 and are holding the nozzle 40, the water supply is turned on. The water running through the water hose 1 is preferably at a pressure of between about 1000 and 2850 psig. The water pressure is preferably similar to that used in standard water hoses. The system 100 is preferably constructed such that the user 150 breathes air or other breathable gas from the breathable gas and water hose apparatus 101 as long as the air supply 102 is available. Thus, a user 150 would only use the breathable gas in the tank 42 of his breathing apparatus 152 which he carries, if the primary air supply 102 is stopped.

It is intended that the foregoing description be only illustrative of the present invention and that the present invention be limited only by the hereinafter appended claims.

Obviously, many modifications and variations of the present invention are possible considering the above teachings and may be practiced otherwise than as specifically described while within the scope of the appended claims.

We claim:

1. A hose apparatus, connectable to an air supply supplying a gas, and a water supply supplying water, said hose apparatus comprising:
a. a flexible water hose extending between a water inlet end and a water outlet end;
b. a gas hose extending between a gas inlet end and a gas outlet end, wherein said water and gas inlet ends are disposed adjacent each other, and said water and gas outlet ends are disposed adjacent each other;
c. an inlet hose end connector attached to said water and gas inlet ends, said inlet hose end connector having a first passageway to receive the water into said hose apparatus independently of the gas and a second passageway to receive the gas into said hose apparatus independently of the water, wherein said first passageway is separated from said second passageway;
d. an outlet hose end connector attached to said water and gas outlet ends, said second hose end connector having a third passageway to allow the water to pass out of said hose apparatus independently of the gas and a fourth passageway to allow the gas to pass out of said hose apparatus independently of the water, wherein said third passageway is separated from said fourth passageway; and
e. an outer jacket made of weather-resistant material, surrounding both said flexible water hose and said gas hose, collectively; wherein said inlet hose end connector includes a first sealing surface facing away from said gas hose to receive and seal said gas inlet end thereagainst.

2. The hose apparatus as set forth in claim 1, wherein each of said flexible water hose and said gas hose are constructed of material which is supple and that will return to its original shape after bending.

3. The hose apparatus as set forth in claim 1 including a nozzle adapter removably securable to said outlet hose end connector, wherein said nozzle adapter includes a nozzle sealing surface facing toward said flexible gas hose to receive and seal said gas inlet end thereagainst.

4. The hose apparatus as set forth in claim 2, wherein said outlet hose end connector includes an outlet sealing surface facing away from said flexible gas hose to receive and seal said outlet sealing surface and said nozzle sealing surface together.

5. The hose apparatus as set forth in claim 4, wherein said inlet hose end connector and said nozzle adapter each define a convex surface to enlarge said inlet and outlet sealing surfaces.

6. The hose apparatus as set forth in claim 4, wherein said first and second hose end connectors each include at least two locking cam surfaces disposed equidistantly about said first and second hose end connectors, respectively, to lock said hose apparatus to the water supply and a fire hose nozzle, respectively.

7. The hose apparatus as set forth in claim 2, wherein said second hose end connector defines a first air hose tube in fluid communication with said gas hose and a second air hose tube fixedly secured to said first air hose tube providing the gas downstream.

8. The hose apparatus as set forth in claim 7, wherein said first and second air hose tubes define first and second air hose diameters such that said second air hose diameter is larger than said first air hose diameter to reduce turbulence in the gas as it moves out of said gas hose.

9. The hose apparatus as set forth in claim 8, wherein said first and second air hose tubes are axially offset from each other.

10. A coupler for coupling a hose apparatus, said coupler comprising:
a. an inlet end and an outlet end;
b. a fluid passageway extending between said inlet and outlet ends for allowing a fluid to pass therethrough;
c. a gas passageway extending between said inlet and outlet ends for allowing a gas to pass therethrough, said gas passageway including a first air hose tube defining a first air hose tube diameter and a second air hose tube defining a second air hose tube diameter, wherein said second air hose tube diameter is larger than said first air hose tube diameter; and
d. an outlet sealing surface facing disposed adjacent said outlet end to provide a surface against which a seal may be created.

11. A coupler as set forth in claim 10 wherein said first air hose tube is axially offset from said second air hose tube.

12. A coupler as set forth in claim 11 including at least one cam locking device for locking said outlet end of said coupler to another device to receive the fluid and the gas passing through said coupler.

13. A coupler as set forth in claim 12 including a pair of pivot wings to pivotally hold said at least one cam locking device to said coupler.

14. A coupler as set forth in claim 13 wherein said outlet sealing surface extends to a convex surface to increase said surface of said outlet sealing surface.
